(19) United States
(12) Patent Application Publication
(10) Pub. No.: US 2002/0059617 A1
(43) Pub. Date: May 16, 2002

(54) Control system

(76) Inventors: Tomoko Terakado, Kanagawa (JP); Nanami Miki, Tokyo (JP)

Correspondence Address: WILLIAM S. FROMMER, Esq., c/o FROMMER LAWRENCE & HAUG LLP, 745 Fifth Avenue, New York, NY, 10151, US

(21) Appl. No.: 09/894,565

(22) Filed: Jun. 28, 2001

(30) Foreign Application Priority Data
Jun. 30, 2000 (JP) P2000-198943

(51) Int. Cl. H04N 7/18

(52) U.S. Cl. 725/80

(57) ABSTRACT

A control system includes a first control apparatus including, at least, a display screen which can also be used as a touch panel. The first control apparatus operates a predetermined electronic apparatus. A second server communicates with the first control apparatus and is connected or linked to a plurality of electronic apparatuses. A third server establishes a connection with the second server through a network. Based on at least one of GUI data, internal processing data, and display data, which are stored or designated by the second server, the first control apparatus changes settings of at least one of GUI data, internal processing data, and display data, which are contained in the first control apparatus.

### BACKGROUND OF THE INVENTION

1. Field of the Invention

The present invention relates to control systems and remote controls. More particularly, the present invention relates to a control system capable of operating a plurality of electronic apparatuses by obtaining data about the electronic apparatuses, namely, the household electrical appliances.

2. Description of the Related Art

Conventionally, household electrical appliances and audio-visual apparatuses, such as video cassette recorders (VCRs), televisions, air conditioners, and lighting apparatuses, are furnished with remote controls. These remote controls each have operation units and functions specific to each apparatus. However, there are also learning-type multifunctional remote controls in which the remote controls for a television and a VCR are integrated into a single remote control. These learning-type multifunctional remote controls have stored remote control signals for major manufacturers beforehand in memory. From among the stored remote control signals, a signal for an apparatus owned by a user is selected, and settings are performed.

In the learning-type remote controls, it is impossible to add additional operation buttons to those already installed at the beginning. Also, it is impossible to add additional functions or to change or delete functions stored in advance in the remote controls. In remote controls for apparatuses such as televisions and VCRs which possess the common functions, only operations common to both, such as power on/off, play, record, fast-forward, rewind, and the like are available in the single remote control. It has so far been impossible to integrate remote controls for home appliances, such as remote controls for an air conditioner and a VCR, which have different functions or different applications, into a single remote control.

### SUMMARY OF THE INVENTION

Accordingly, it is an object of the present invention to integrate the functions of remote controls for various household electrical apparatuses and audio-visual apparatuses into a single remote control and to allow easy changing of these functions.

According to an aspect of the present invention, the foregoing objects are achieved through provision of a control system including a first control apparatus which includes, at least, a display screen which can also be used as a touch panel, in which the first control apparatus operates a predetermined electronic apparatus. A second server communicates with the first control apparatus, and the second server is connected or linked to a plurality of electronic apparatuses. A third server establishes a connection with the second server by a network. The first control apparatus can change settings of at least one of GUI data, internal processing data, and display data, which are contained in the first control apparatus, based on at least one of GUI data, internal processing data, and display data, which are stored or designated by the second server.

The first control apparatus may include a remote control.

The network may include the Internet.

The electronic apparatuses may include home appliances and audio-visual apparatuses.

The display screen of the first control apparatus may be a liquid crystal display screen.

The second server may receive information recorded by the third server through the network. The second server may transfer the received information to the first control apparatus using wired or wireless communications.

Communication data communicated among the first control apparatus, the second server, and the third server may include meta-data.

The second server may include control data for the electronic apparatuses. The first control apparatus may receive the control data for a specific electronic apparatus from the second server and may use the data as the internal processing data.

The second server may download the control data from the third server.

The first control apparatus may further include a display unit for combining the control data for the electronic apparatuses and displaying the combined data.

The first control apparatus may download data received from the second server to the electronic apparatuses which are connected or linked to the second server.

The data may include data downloaded from the third server.

The data may include an electronic program guide.

The second server and the electronic apparatuses may be connected by link connection with a digital interface which conforms to the IEEE 1394 specification standard.

According to another aspect of the present invention, the foregoing objects are achieved through provision of a control system which includes a first control apparatus including, at least, a display screen which can also be used as a touch panel, in which the first control apparatus operates a predetermined electronic apparatus. A second server communicates with the first control apparatus, and the second server is connected or linked to a plurality of electronic apparatuses. The first control apparatus changes settings of at least one of GUI data, internal processing data, and display data, which are contained in the first control apparatus, based on at least one of GUI data, internal processing data, and display data, which are stored or designated by the second server.

The first control apparatus may include a remote control.

The electronic apparatuses may include home appliances and audio-visual apparatuses.

The display screen of the first control apparatus may include a liquid crystal display screen.

The first control apparatus may transfer the information contained therein to the second server using wired or wireless communications.

Communication data communicated between the first control apparatus and the second server may include meta-data.

The second server may include control data for the electronic apparatuses. The first control apparatus may receive the control data for a specific electronic apparatus from the second server and may use the data as the internal processing data.

The first control apparatus may further include a display unit for combining the control data for the electronic apparatuses and displaying the combined data.

The first control apparatus may download data received from the second server to the electronic apparatuses which are connected or linked to the second server.

The data may include an electronic program guide.

The second server and the electronic apparatuses may be connected by link connection with a digital interface which conforms to the IEEE 1394 specification standard.

Accordingly, various information and data are downloaded from a second server connected or linked to a plurality of electronic apparatuses to a first control apparatus, namely, a remote control. Thus, the single remote control can operate the electronic apparatuses and change data, such as upgrading the version. Functions of remote controls for the electronic apparatuses are integrated into the single remote control, and the functions can be changed easily.

According to the present invention, functions of remote controls for a plurality of home appliances are integrated into a single remote control. It is no longer necessary to possess a plurality of remote controls. When a new home appliance is purchased, it is only necessary to add remote control data concerning the purchased home appliance. When adding, changing, or deleting the functions of a remote control for each home appliance, it is only necessary to download the most recent data from a home server and to update the corresponding functions. The layout of a display screen of the remote control can also be changed, and hence users can rearrange the Layout in accordance with their preferences.

### BRIEF DESCRIPTION OF THE DRAWINGS

FIG. 1 is a schematic diagram of a home network system in which a control apparatus according to an embodiment of the present invention is used to control home appliances;

FIG. 2 is an external view of the control apparatus according to the embodiment of the present invention;

FIG. 3 illustrates the arrangement of a display screen of the control apparatus according to the embodiment of the present invention; and

FIG. 4 is a block diagram of the internal structure of the control apparatus according to the embodiment of the present invention.

### DESCRIPTION OF THE PREFERRED EMBODIMENTS

The present invention will become apparent from the following description of the preferred embodiment with reference to the accompanying drawings.

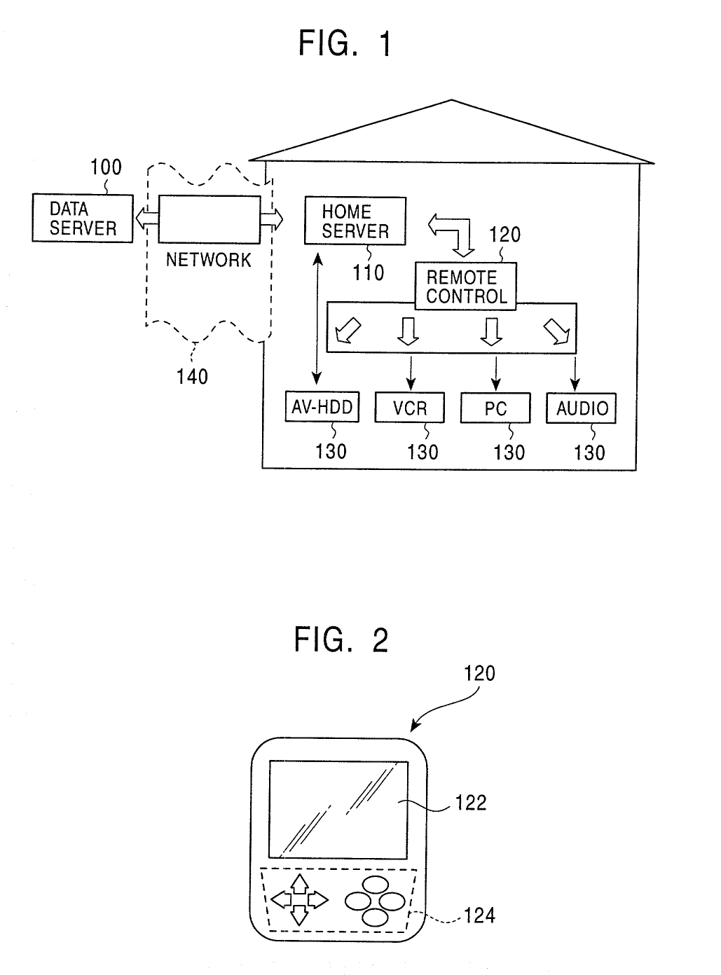

A home network shown in FIG. 1 includes a data server 100, which is a third server. The data server 100 is connected to a home server 110, which is a second server, through a network. The home server 110, i.e., the second server, is capable of communicating with a remote control 120, which is a first control apparatus, and the home server 110 is connected or linked to a plurality of electronic apparatuses. The remote control 120 includes, at least, a display screen which can also be used as a touch panel, and the remote control 120 is linked to the electronic apparatuses. The electronic apparatuses are home appliances 130. The data server 100 is connected to the home server 110 through a network 140.

The data server 100, i.e., the third server, may be located at one place or at several places throughout the network 140. The data server 100 stores various control data, graphical user interface (GUI) data, internal processing data, display data, electronic program guide (EPG) data, and the like for the remote control 120 which controls the home appliances 130. The data are stored as extensible markup language (XML) meta-data or the like, and hence the data can be handled as the single type of data, regardless of the type of apparatus.

The home server 110, i.e., the second server, includes a connecting section for establishing a connection with the data server 100, a storing section for downloading and storing the data stored in the data server 100, and a communication section for establishing a connection or link with the home appliances 130 and performing wired or wireless data communication with the home appliances 130. Data downloading can be performed automatically or in response to an instruction given by the remote control 120 or a notification given by the data server 100. Connection between the home server 110 and the electronic apparatuses, namely, the home appliances 130, is established by establishing a link (i.LINK (trademark of Sony Corporation) in this embodiment) with a digital interface which conforms to the IEEE 1394 specification standard.

Referring to FIG. 2, the remote control 120, i.e., the first control apparatus, includes a data obtaining unit for establishing a wired connection or a wireless link with the home server 110 and for obtaining various control data and GUI data, internal processing data, display data, EPG data, and the like for the remote control 120 which controls the home appliances 130. A display screen 122 displays the obtained data using an integrated screen. Operation keys 124 are used to operate the home server 110 and the home appliances 130.

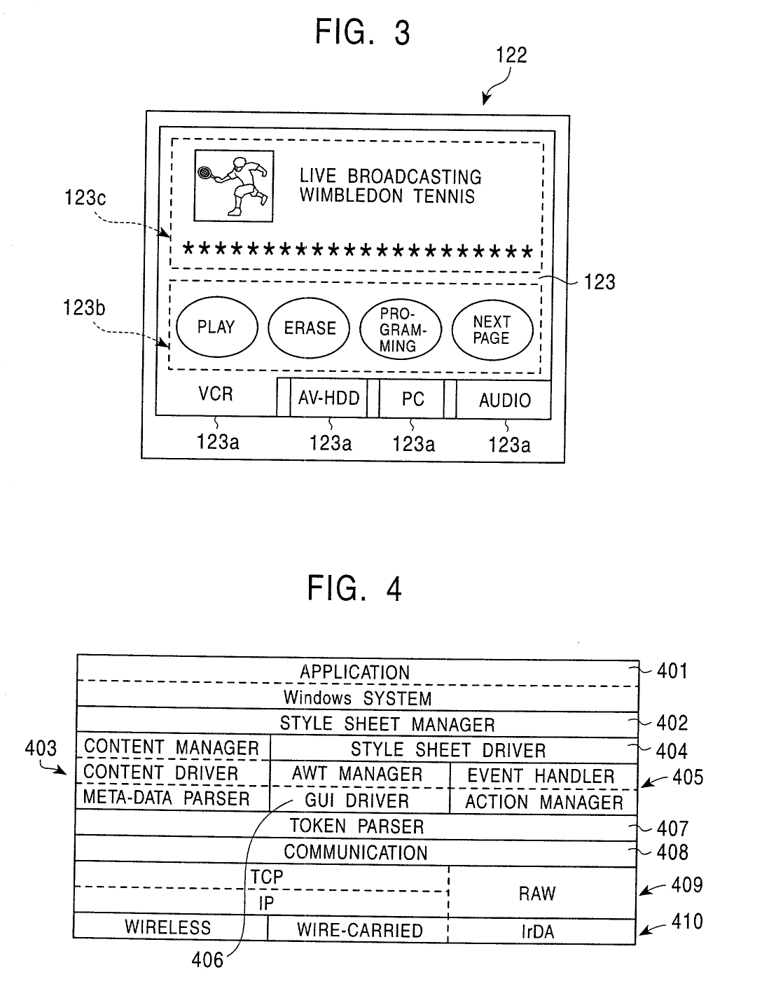

Referring to FIG. 3,, the display screen 122 is integrated in such a manner that it is possible to view a single screen which combines operation panels 123 for the electronic apparatuses or the home appliances 130 such as a video cassette recorder (VCR), audio-visual hard disk drive (AV-HDD), personal computer (PC), and audio equipment. The operation panel 123 for the home appliance currently in use (VCR in the example shown in FIG. 3) is displayed in the foreground.

The operation panel 123 is a touch panel. The operation panel 123 includes index sections 123a for displaying the names of the home appliances 130, operation buttons 123b for operating the home appliances 130, and an information display section 123c for displaying information contained in the home appliances 130, such as the title of a song on a compact disk (CD) or the title of a program recorded in the AV-HDD, and EPG data. When operating a desired home appliance, the corresponding index section 123a is touched, and the corresponding operation panel 123 for the desired home appliance is displayed in the foreground.

FIG. 4 shows the internal structure of the remote control 120. As shown in FIG. 4, an application unit 401 includes application for managing a program which runs in the operation panels 123 for the home appliances 130, and a Windows system for controlling the operation panels 123. A style sheet manager 402 controls style sheets concerning GUI data. A content control unit 403 includes a control manager which displays and controls content displayed by the application unit 401, a content driver, and a meta-data parser. A style sheet driver 404 displays elements other than content, namely, the operation buttons 123b and text data area (the information display section 123c), and the style sheet driver 404 integrates actions in response to events. A key control unit 405 includes an event handler for performing key control of elements forming the screen and an action manager. A screen arrangement control unit 406 includes an AWT (Advances Windowing Toolkit) manager and a GUI driver and controls the screen arrangement. A token parser 407 classifies transmitted data as either content or elements (GUI parts) and performs settings. A communication unit 408 functions as an interface between a communication device 409 and other sections. The communication device 409 includes TCP, IP, and RAW, which rearrange transmitted data (packets) in order of transmission and perform error correction and packet transfer (route control). An interface 410 includes physical interfaces, namely, wireless, wire-carried, and IrDA interfaces, with wireless, wired, and infrared communication sections, respectively.

As shown in FIG. 1, the home appliances 130, i.e., the electronic apparatuses, include audio-visual equipment such as an HDD recorder, VCR deck, PC, and audio equipment. These home appliances 130 are connected to the home server 110 by a bus connection, daisy chain, or the like. In response to an instruction from the remote control 120, the home appliances 130 perform predetermined processing and download predetermined data from the home server 110. The type of home appliance is not limited to those described in this embodiment but can be any home appliance so long as it can be operated by remote control.

The operation of the home network system which includes the data server 100, the home server 110, the remote control 120, and the home appliances 130 is described with reference to FIGS. 1 to 4.

The manner in which a remote control function of each of the home appliances 130 is installed or updated in the remote control 120 is described. From the data server 100, the home server 110 downloads and stores GUI data, internal processing data, and display data, which concern the display screen 122 of the remote control 120, and control data for the remote control 120 automatically or in response to an instruction from the remote control 120 or a notification from the data server 100.

The remote control 120 gains access to the home server 100 using wired or wireless communications, obtains the stored GUI data, internal processing data, display data, control data, and the like which are downloaded from the data server 100, and then updates the data. For example, when an additional button is added to the operation buttons 123b (play, erase, programming, and next page) shown in FIG. 3 or the operation buttons 123b are deleted or changed, or when a new home appliance is installed, the new button or the new home appliance is appended to the overall operation panels 123 shown in FIG. 3, and a new layout of the operation panels 123 is arranged and displayed. The layout can be changed in accordance with user's preferences.

Functions of each of the home appliances 130 are updated by instructions from the remote control 120. The home server 110 downloads new function data concerning the home appliance 130 from the data server 130 and stores the data automatically or in response to an instruction from the remote control 120 or a notification from the data server 100. When the remote control 120 gains access to the home server 110, the remote control 120 is notified that the new function data is stored, or the remote control 120 searches the data. Accordingly, the remote control 120 instructs the corresponding home appliance 130 to download the new function data from the home server 110 and to update the function.

The home appliance 130 receives the instruction from the remote control 120 and downloads the predetermined new function data from the home server 110 to which the home appliance 130 is connected by a bus connection or daisy chain. For example, the home appliance 130 overwrites the written contents of memory in the home appliance 130 and updates the function. Alternatively, the remote control 120 can instruct the home server 110 to transfer the stored new function data to the home appliance 130.

When the new function data is added and the function is updated by the home appliance 130, a new operation button or the like is also added to the remote control 120. In such a case, as described above, the remote control 120 obtains predetermined data from the home server 110 and updates the function.

Since the home appliance 130 is connected to the home server 110 by a bus connection or daisy chain, for example, the home appliance 130 can transfer information contained in the home appliance 130, such as the title of a song on a CD or the title of a program recorded in the AV-HDD, to the home server 110, and the home server 110 may in turn transfer the information to the remote control 120 to display the information on the display screen 122.

A case in which programming is performed to record a particular program based on the EPG data is described. The home server 110 downloads the EPG data from the data server 100 and stores the data automatically or in response to an instruction from the remote control 120 or a notification from the data server 100. The remote control 120 gains access to the home server 110 and obtains the EPG data.

The EPG data obtained by the remote control 120 is displayed on the display screen 122. After a user confirms content of the program, the remote control 120 directly transfers the programming information to the home appliance 130 (VCR in this case) in order to record the desired program. Alternatively, the remote control 120 may instruct the home server 110 to perform programming to record the desired program, and the home server 110 in turn instructs the home appliance 130 to perform the programming to record the program.

What is claimed is:

1. A control system comprising:
a first control apparatus comprising, at least, a display screen which can also be used as a touch panel, said first control apparatus operating a predetermined electronic apparatus;
a second server for communicating with said first control apparatus, said second server being connected or linked to a plurality of electronic apparatuses;
a third server for establishing a connection with said second server by a network;
wherein said first control apparatus changes settings of at least one of GUI data, internal processing data, and display data, which are contained in said first control apparatus, based on at least one of GUI data, internal processing data, and display data, which are stored or designated by said second server.

2. A control system according to claim 1, wherein said first control apparatus comprises a remote control.

3. A control system according to claim 1, wherein the network comprises the Internet.

4. A control system according to claim 1, wherein the electronic apparatuses comprise home appliances and audio-visual apparatuses.

5. A control system according to claim 1, wherein the display screen of said first control apparatus comprises a liquid crystal display screen.

6. A control system according to claim 1, wherein said second server receives information recorded by said third server through the network; and
said second server transfers the received information to said first control apparatus using wired or wireless communications.

7. A control system according to claim 1, wherein communication data communicated among said first control apparatus, said second server, and said third server comprise meta-data.

8. A control system according to claim 1, wherein said second server includes control data for the electronic apparatuses; and
said first control apparatus receives the control data for a specific electronic apparatus from said second server and uses the data as the internal processing data.

9. A control system according to claim 8, wherein said second server downloads the control data from said third server.

10. A control system according to claim 1, wherein said first control apparatus further comprises display means for combining the control data for the electronic apparatuses and displaying the combined data.

11. A control system according to claim 1, wherein said first control apparatus downloads data received from said second server to the electronic apparatuses which are connected or linked to said second server.

12. A control system according to claim 11, wherein the data includes data downloaded from said third server.

13. A control system according to claim 12, wherein the data includes an electronic program guide.

14. A control system according to claim 1, wherein said second server and the electronic apparatuses are connected by link connection with a digital interface which conforms to the IEEE 1394 specification standard.

15. A control system comprising:
a first control apparatus comprising, at least, a display screen which can also be used as a touch panel, said first control apparatus operating a predetermined electronic apparatus; and
a second server for communicating with said first control apparatus, said second server being connected or linked to a plurality of electronic apparatuses;
wherein said first control apparatus changes settings of at least one of GUI data, internal processing data, and display data, which are contained in said first control apparatus, based on at least one of GUI data, internal processing data, and display data, which are stored or designated by said second server.

16. A control system according to claim 15, wherein said first control apparatus comprises a remote control.

17. A control system according to claim 15, wherein the electronic apparatuses comprise home appliances and audio-visual apparatuses.

18. A control system according to claim 15, wherein the display screen of said first control apparatus comprises a liquid crystal display screen.

19. A control system according to claim 15, wherein said first control apparatus transfers the information contained therein to said second server using wired or wireless communications.

20. A control system according to claim 15, wherein communication data communicated between said first control apparatus and said second server comprise meta-data.

21. A control system according to claim 15, wherein said second server includes control data for the electronic apparatuses; and
said first control apparatus receives the control data for a specific electronic apparatus from said second server and uses the data as the internal processing data.

22. A control system according to claim 15, wherein said first control apparatus further comprises display means for combining the control data for the electronic apparatuses and displaying the combined data.

23. A control system according to claim 15, wherein said first control apparatus downloads data received from said second server to the electronic apparatuses which are connected or linked to said second server.

24. A control data according to claim 23, wherein the data includes an electronic program guide.

25. A control system according to claim 15, wherein said second server and the electronic apparatuses are connected by link connection with a digital interface which conforms to the IEEE 1394 specification standard.
